(19) United States
(12) Patent Application Publication
(10) Pub. No.: US 2009/0195752 A1
(43) Pub. Date: Aug. 6, 2009

(54) Projector and digital micor-mirror device module

(75) Inventors: Sze-Ke Wang, Hsin-Chu (TW); Chin-Ku Liu, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/292,784

(22) Filed: Nov. 26, 2008

(30) Foreign Application Priority Data
Feb. 4, 2008 (TW) 097104139

(51) Int. Cl. G03B 21/14; G03B 21/28

(52) U.S. Cl. 353/22; 353/37

(57) ABSTRACT

A projector includes a light source system for providing an incident light, a digital micro-mirror device (DMD) module and a projection lens. The digital micro-mirror device module is disposed in the light path of the incident light for receiving and modulating the incident light before reflecting the incident light to form an image light. The projection lens is to receive and project the image light to form an image. The DMD module includes an active area plane and a cover glass. The active area plane has plural digital micro-mirror elements for reflecting the incident light to form an image light. The cover glass is disposed in the light paths of the incident light and image light, and has a first transparent surface and a second transparent surface. An included angle is formed between the extension direction of the first transparent surface and the extension direction of the active area plane.

### BACKGROUND OF THE INVENTION

(1) Field of the Invention

The invention relates to a projector, particularly to a projector capable of reducing the ghost shadow of the image via improving the digital micro-mirror device.

(2) Description of the Prior Art

Digital Light Processing(DLP) projector is the projection system developed by Texas Instrument(TI), applying mirror reflection principle to imaging and owning the advantages of full digital, high contrast and exquisite image. Meanwhile, the projector using this technology is capable of effectively reducing its volume and weight, achieving light, thin, short and small.

Referring to FIG. 1 for a schematic view of the conventional DLP projector, the DLP projector projects image to a screen 4, including at least a light source system 10, a digital micro-mirror device(DMD) module 20 and a projection lens 30.

Referring to FIG. 2 for a sectional view of the above DLP projector as well, the operation of a projector is the DMD module 20 modulating the incident light from the light source system 10 and reflecting the incident light to form an image light to the screen 4 outside the projector via the projection lens 30.

The light source system 10 is composed of a light source device, a color filter rotary disc, a focusing lens, etc. The DMD module 20, also called “light valve”, has an active area plane 22 to modulate the incident light from the light source system 10 and reflect the incident light to form the effective image light to the projection lens 30.

The active area plane 22 is composed of the reflection groups of a plurality of digital micro-mirror elements. The DMD module is capable of controlling the deflection angle and deflection time of the reflection lens in each digital micro-mirror elements via digital signal, so as to reflect the incident light to the projection lens 30 to form full color image with high resolution.

In conventional technology, the DMD module 20 further includes a bottom plate 21, a cover glass 23, a frame 24 and a seal structure 25 besides the active area plane 22.

As FIG. 2 shows, the active area plane 22 is disposed on the bottom plate 21, while the cover glass 23 is disposed in front of the active area plane 22 in parallel and side by side, and located in the light paths of the incident light and the image light. The frame 24 is generally disposed around the cover glass 23, while the ring seal structure 25 seals the active area plane 22 between the bottom plate 21 and the cover glass 23.

The digital micro-mirror elements including the active area plane 22 are very precise optical components, so the settings of the cover glass 23, the frame 24 and the seal structure 25 need to be capable of effectively preventing the dust, vapor, etc.

However, the DMD module 20 with the cover glass 23 usually has following problems:

1. As FIG. 2 shows, during the incident light from the light source system 10 entering the active area plane 22 of the DMD module 20, the incident light goes through a first transparent surface 231 and a second transparent surface 232 at two sides of the cover glass 23, while the first transparent surface 231 and the second transparent surface 232 generate stray light by reflecting part of the incident light. When using the projection lens 30 and the light source system 10 with large diaphragm, the angle difference between the stray light of the cover glass 23 and the image light of the active area plane 22 is not large enough, so the stray light of the cover glass 23 easily enters the projection lens 30 to form ghost shadow in the image, influencing the image contrast and quality.

2. In the conventional technology, to solve the above ghost shadow problem, an anti-reflection film is often coated on the first transparent surface 231 and the second transparent surface 232 of the cover glass 23 to reduce stray light, but the coating of the anti-reflection film needs rather high cost.

In this regard, for the conventional technology still has defects, it is necessary to provide an effective solution for practical use.

### SUMMARY OF THE INVENTION

The object of the present invention is to reduce the ratio of the stray light entering the projection lens by changing the shape or configuration of the cover glass, and improve the ghost shadow of the image with better image quality and contrast.

The another object of the present invention is to apply in a design of the projection lens or light source system with larger diaphragm to raise the brightness of the image, without worrying about the stray light lowering contrast.

The projector in the embodiment of the present invention includes a light source system, a digital micro-mirror device (DMD) module and a projection lens.

The light source system provides the incident light. The DMD module is disposed in the light path of the incident light for receiving and modulating the incident light before reflecting the incident light to form an image light. The projection lens is to receive the image light reflected from the DMD module, and the image light is projected to form an image on a screen outside the projector by the projection lens.

The DMD module has an active area plane and a cover glass, where the active area plane is composed of a plurality of digital micro-mirror elements to generate the image light. The cover glass is disposed in the light paths of the incident light and image light, apart from the active area plane. The cover glass has a first transparent surface and a second transparent surface at the opposite sides of the cover glass, where an included angle is formed between the extension direction of the first transparent surface and the extension direction of the active area plane.

According, during the incident light entering the first transparent surface of the cover glass, the reflection angle of the stray light in the embodiment of the present invention is larger than the conventional. The stray light is hard to enter the projection lens, so the ghost shadow of the image is capable of being reduced.

In the embodiment of the invention, the cover glass is a board structure with the first transparent surface parallel to the second transparent surface.

In another embodiment of the invention, the cover glass is a wedge structure with an included angle between the extension direction of the first transparent surface and the extension direction of the second transparent surface.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiment illustrated in the drawings, in which

FIG. 1 is a schematic view of the conventional DLP projector;

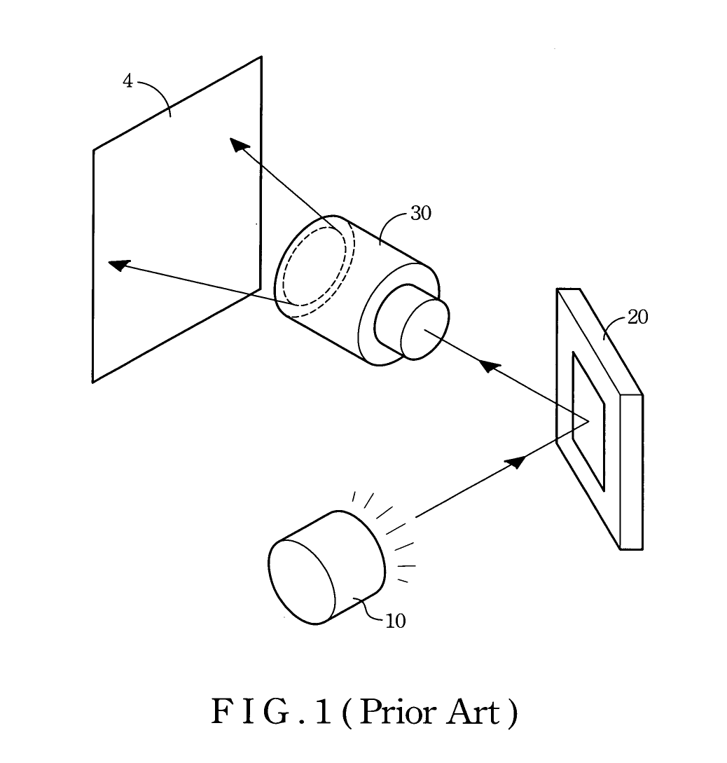

FIG. 2 is a sectional view of the DLP projector in FIG. 1;

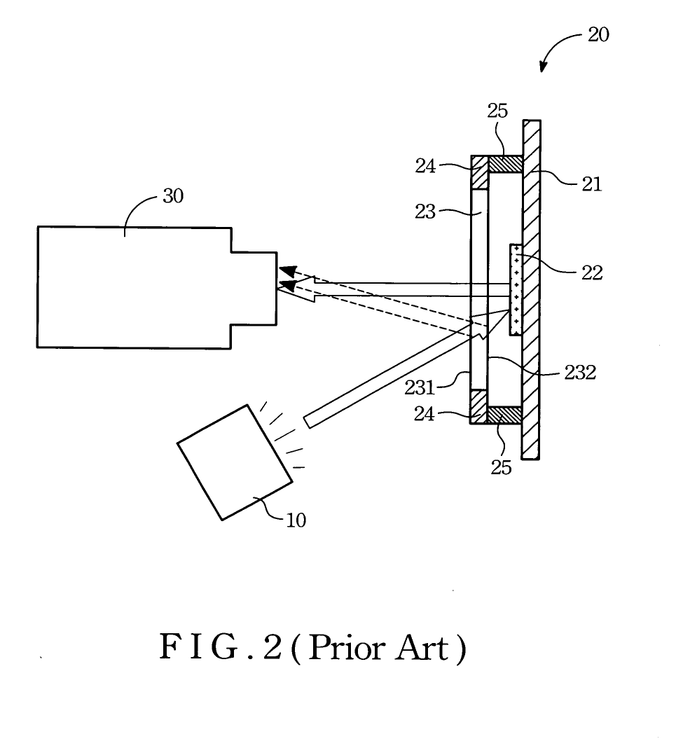

FIG. 3 is a sectional view showing the first embodiment of the projector according to the present invention; and

FIG. 4 is a sectional view showing the second embodiment of the projector according to the present invention.

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

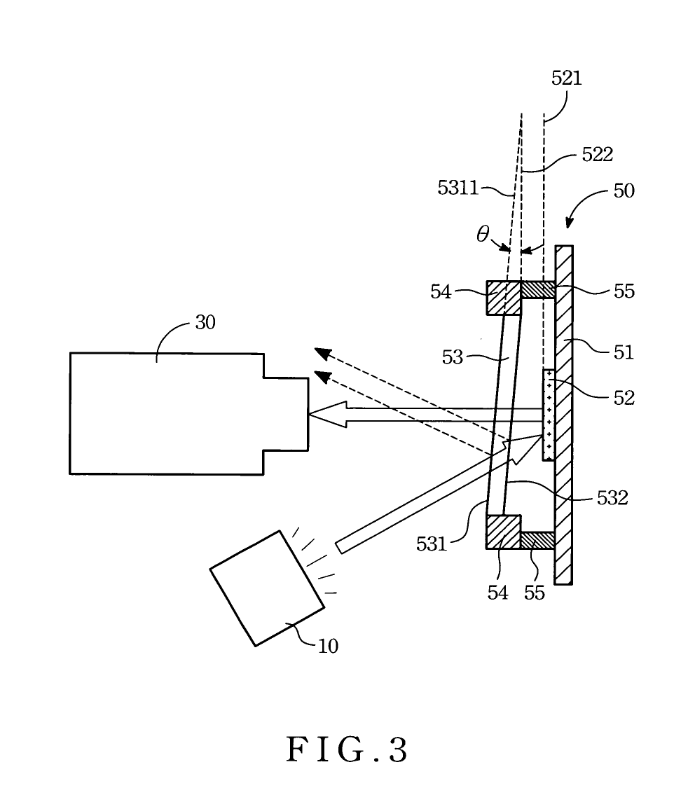

Referring to FIG. 3 for a sectional view showing the embodiment of a projector according to the present invention, the projector includes a light source system 10, a digital micro-mirror device (DMD) module 50 and a projection lens 30.

The light source system 10 is composed of a light source device, a color filter rotary disc, a focusing lens, etc, providing the incident light. The DMD module 50 is disposed on the light path of the incident light for receiving and modulating the incident light, so as to reflect the incident light to form an image light. The projection lens 30 is to receive the image light reflected by the DMD module 50, and the image light is projected to form an image on a screen outside the projector by the projection lens 30.

The DMD module 50 has an active area plane 52 and a cover glass 53, where the active area plane 52 is composed of a plurality of digital micro-mirror elements to generate the image light.

The cover glass 53 is disposed in the light paths of the incident light and image light, apart from the active area plane 52. The cover glass 53 has a first transparent surface 531 and a second transparent surface 532 at the opposite sides of the cover glass 53, where an included angle θ is formed between the extension direction 5311 of the first transparent surface 531 and the extension direction 521 of the active area plane 52. Noticeably, the reference line 522 (parallel to the extension direction 521 of the active area plane 52) and the extension direction 5311 of the first transparent surface 531 are used to clearly display the angle θ.

In this embodiment, the cover glass 53 is a board structure with the first transparent surface 531 parallel to the second transparent surface 532. Meanwhile, the DMD module 50 further includes a bottom plate 51, a frame 54 and a seal structure 55.

The active area plane 52 is disposed on the bottom plate 51. The frame 54 is a ring-shaped structure assembled round the cover glass 53, while the cover glass 53 is disposed inside the frame 54 and inclined to the active area plane 52. The seal structure 55 is assembled between the frame 54 and the bottom plate 51 to seal the active area plane 52 between the bottom plate 51 and the cover glass 53, so as to effectively prevent the dust, vapor, etc from entering the active area plane 52.

According to the above embodiment, during the incident light from the light source system 10 entering the active area plane 52 of the DMD module 50, the inclined setting of the cover glass 53 makes larger reflection angle for the stray light from the first transparent surface 531 and the second transparent surface 532. The stray light is hard to enter the projection lens 30, so the ghost shadow of the image is capable of being reduced. At this time, the light in the projection lens 30 is almost only the effective image light reflected by the active area plane 52, thus the image has an excellent quality.

Noticeably, it is found in the experiment that if only the θ=1 degree(the cover glass 53 inclining 1 degree) in the embodiment, the ghost shadow energy reduces 99%, compared to the conventional design(θ=0), with an obvious effect.

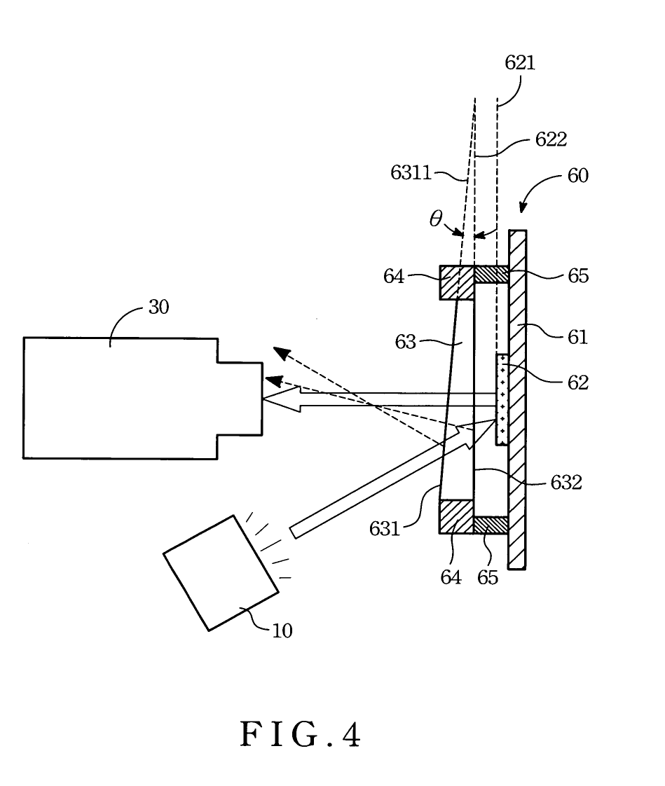

Referring to FIG. 4 for the sectional view showing the second embodiment of the projector according to the present invention, similarly, the DMD module 60 has an active area plane 62 and a cover glass 63. The cover glass 63 is disposed in the light paths of the incident light and image light, apart from the active area plane 62. The cover glass 63 has a first transparent surface 631 and a second transparent surface 632 at the opposite sides of the cover glass 63.

An included angle θ is formed between the extension direction 6311 of the first transparent surface 631 and the extension direction 621 of the active area plane 62. Noticeably, the reference line 622 (parallel to the extension direction 621 of the active area plane 62) and the extension direction 6311 of the first transparent surface 631 are used to clearly display the angle θ.

In this embodiment, the cover glass 63 is a wedge structure with an included angle between the extension direction of the first transparent surface 631 and the extension direction of the second transparent surface 632. Meanwhile, the DMD module 60 further includes a bottom plate 61, a frame 64 and a seal structure 65.

The active area plane 62 is disposed on the bottom plate 61. The frame 64 is a ring-shaped structure assembled round the cover glass 63. The seal structure 65 is assembled between the frame 64 and the bottom plate 61 to seal the active area plane 62 between the bottom plate 61 and the cover glass 63, so as to effectively prevent the dust, vapor, etc from entering the active area plane 62.

According to the above embodiment, during the incident light from the light source system 10 entering the active area plane 62 of the DMD module 60, the stray light from the first transparent surface 631 of the cover glass 63 has a larger reflection angle and it is hard to enter the projection lens 30, so the ghost shadow of the image is capable of being reduced.

In conclusion, the projector and the DMD module in above embodiment have following advantages:

1. The ratio of the stray light from the cover glass entering the projection lens is capable of being reduced by changing the shape or configuration of the cover glass, so that the ghost shadow of the image in the conventional technology is capable of being improved, and better image quality and contrast are carried out.

2. The projection lens or the light source system with larger diaphragm is capable of being applied in design to raise the brightness of the image, without worrying about the ghost shadow and contrast loss.

3. The embodiment of the present invention is focusing on changing the shape or configuration of the cover glass and without changing the relative positions of the active area plane and the projection lens, so the image quality is not influenced.

4. The fabrication cost is capable of being reduced for no extra anti-reflection film coated on the first transparent surface and the second transparent surface of the cover glass.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector, comprising:
a light source system, providing an incident light;
a digital micro-mirror device module, disposed on the light path of the incident light for receiving and modulating the incident light before reflecting the incident light to form an image light, the digital micro-mirror device module comprising:
an active area plane, having a plurality of digital micro-mirror elements for reflecting the incident light to form the image light; and
a cover glass, disposed in the light paths of the incident light and the image light, apart from the active area plane, having a first transparent surface and a second transparent surface at the opposite sides of the cover glass, wherein an included angle is formed between the extension direction of the first transparent surface and the extension direction of the active area plane; and
a projection lens, receiving the image light reflected from the digital micro-mirror device module and projecting the image light to form an image.

2. The projector of claim 1, wherein the cover glass comprises a board structure with the first transparent surface parallel to the second transparent surface.

3. The projector of claim 1, wherein the cover glass comprises a wedge structure with an included angle between the extension direction of the first transparent surface and the extension direction of the second transparent surface.

4. The projector of claim 1, wherein the digital micro-mirror device module further comprises:
a bottom plate, for the active area plane disposed on;
a frame, disposed around the cover glass; and
a seal structure, sealing the active area plane between the bottom plate and the cover glass.

5. A digital micro-mirror device module, used in a projector to modulate an incident light provided by a light source system and reflect the incident light to form an image light, the digital micro-mirror device module comprising:
an active area plane, having a plurality of digital micro-mirror elements for reflecting the incident light to form the image light; and
a cover glass, disposed on the light paths of the incident light and the image light, apart from the active area plane, having a first transparent surface and a second transparent surface at the opposite sides of the cover glass, wherein an included angle is formed between the extension direction of the first transparent surface and the extension direction of the active area plane.

6. The digital micro-mirror device module of claim 5, wherein the cover glass comprises a board structure with the first transparent surface parallel to the second transparent surface.

7. The digital micro-mirror device module of claim 5, wherein the cover glass comprises a wedge structure with an included angle between the extension direction of the first transparent surface and the extension direction of the second transparent surface.

8. The digital micro-mirror device module of claim 5, further comprising:
a bottom plate, for the active area plane disposed on;
a frame, disposed around the cover glass; and
a seal structure, sealing the active area plane between the bottom plate and the cover glass.
